(19) United States
(12) Patent Application Publication
(10) Pub. No.: US 2022/0228962 A1
(43) Pub. Date: Jul. 21, 2022

(54) ANALYSIS METHOD, ANALYSIS DEVICE, AND PROGRAM

(71) Applicant: SUMITOMO HEAVY INDUSTRIES, LTD., Tokyo (JP)

(72) Inventors: Nariaki Matsumiya, Kanagawa (JP); Ryouta Hirose, Kanagawa (JP)

(21) Appl. No.: 17/576,516

(22) Filed: Jan. 14, 2022

(30) Foreign Application Priority Data
Jan. 15, 2021 (JP) 2021-005156

(51) Int. Cl. G01N 15/00; G06F 30/25; G06F 30/28

(52) U.S. Cl. CPC G01N 15/00; G06F 2111/10; G06F 30/28; G06F 30/25

(57) ABSTRACT

An analysis method of analyzing a behavior of a particle system that includes a plurality of particles forming a flow field by using a renormalized molecular dynamics method, includes: performing renormalization on the particle system according to a degree of renormalization determined for each of three orthogonal directions according to a shape of the flow field; and numerically solving a motion equation governing a motion of the particle system with respect to the particle system after the renormalization, in which in the performing of renormalization, the number of particles is reduced according to the degree of renormalization, and the mass of each particle is increased according to the degree of renormalization without changing the shape and volume of the flow field before and after the renormalization, and an interaction potential between the particles is transformed according to the degree of renormalization in each of the three directions.

### RELATED APPLICATIONS

The content of Japanese Patent Application No. 2021-005156, on the basis of which priority benefits are claimed in an accompanying application data sheet, is in its entirety incorporated herein by reference.

### BACKGROUND

### Technical Field

Certain embodiments of the present invention relate to an analysis method, an analysis device, and a program for analyzing the behavior of a particle systemby using a renormalized molecular dynamics method.

### Description of Related Art

In an analysis method by a molecular dynamics method, a motion equation that governs a particle system is numerically solved with respect to each of a plurality of particles configuring a system to be analyzed. If the number of particles of the particle system to be analyzed increases, the amount of required calculation also increases. A renormalized molecular dynamics method that reduces the amount of calculation by reducing the number of particles of the particle system to be analyzed in order to reduce the amount of calculation necessary for analysis is known (refer to, for example, the related art).

### SUMMARY

According to an embodiment of the present invention, there is provided an analysis method of analyzing a behavior of a particle system that includes a plurality of particles forming a flow field, by using a renormalized molecular dynamics method, including:
performing renormalization on the particle system according to a degree of renormalization determined for each of three directions orthogonal to each other according to a shape of the flow field by the particle system to be analyzed; and
numerically solving a motion equation that governs a motion of the particle system with respect to the particle system after the renormalization,
in which in the performing of renormalization,
a number of particles is reduced according to the degree of renormalization, and mass of each of the particles is increased according to the degree of renormalization without changing a shape and volume of the flow field before and after the renormalization, and
an interaction potential between the particles is transformed according to the degree of renormalization in each of the three directions.

According to another embodiment of the present invention, there is provided an analysis device for analyzing a behavior of a particle system that includes a plurality of particles forming a flow field, including:
an input/output device to which analysis information that includes information for defining a shape of the flow field to be analyzed and information for defining a degree of renormalization for each of three directions orthogonal to each other in the flow field to be analyzed is input; and
a processing device that analyzes the behavior of the particle system by using a renormalized molecular dynamics method, based on the analysis information input from the input/output device,
in which the processing device is capable of
performing renormalization that reduces a number of particles according to the degree of renormalization, and increases mass of each of the particles according to the degree of renormalization without changing the shape and volume of the flow field before and after the renormalization,
transforming an interaction potential between the particles according to the degree of renormalization in each of the three directions, and
numerically solving a motion equation that governs a motion of the particle system with respect to the particle system after the renormalization.

According to still another embodiment of the present invention, there is provided a computer readable medium storing a program that causes a computer to execute a process for analyzing a behavior of a particle system that includes a plurality of particles forming a flow field, the process including:
acquiring analysis information that includes information for defining a shape of the flow field to be analyzed and information for defining a degree of renormalization for each of three directions orthogonal to each other in the flow field to be analyzed;
performing renormalization that reduces a number of particles according to the degree of renormalization, and increases mass of each of the particles according to the degree of renormalization without changing the shape and volume of the flow field before and after the renormalization;
transforming an interaction potential between the particles according to the degree of renormalization in each of the three directions, and
numerically solving a motion equation that governs a motion of the particle system with respect to the particle system after the renormalization.

### BRIEF DESCRIPTION OF THE DRAWINGS

FIG. 1 is a block diagram of an analysis device according to an example.

FIG. 2A is a schematic diagram of an analysis model in which a fluid to be analyzed is represented by a plurality of particles,

FIG. 2B is a schematic diagram showing a particle system in which isotropic renormalization has been performed on the particle system shown in FIG. 2A, and FIG. 2C is a schematic diagram showing a particle system in which renormalization has been further performed in an x direction and a y direction on the particle system shown in FIG. 2B without performing renormalization in a z direction.

FIG. 3 is a flowchart of an analysis method according to the example.

FIG. 4 is a schematic diagram showing an analysis model in which analysis is actually performed.

FIG. 5 is a graph showing analysis results.

### DETAILED DESCRIPTION

In a general renormalized molecular dynamics method, isotropic renormalization is performed on a particle system. Ina case of performing the isotropic renormalization on a system having a large aspect ratio, the degree of renormalization (the number of times of renormalization) is limited according to the dimension in a direction of the smallest dimension. Therefore, the effect of reducing the amount of calculation is limited.

The related art describes that it is also possible to perform renormalization having anisotropy. If the anisotropic renormalization is performed by the method described in the related art, the dimensions of a system in an x direction, a y direction, and a z direction orthogonal to each other change, and the shape of the entire system becomes different before and after the renormalization. Therefore, it is difficult to perform analysis that reproduces a flow field to be analyzed.

It is desirable to provide an analysis method, an analysis device, and a program, in which even if anisotropic renormalization is performed on a particle system to be analyzed, the state of a flow field is sufficiently reflected and a sufficient effect of reducing the amount of calculation can be obtained.

Since the shape and volume of the flow field is invariable even if anisotropic renormalization is performed, it is possible to perform analysis that reproduces the flow field by the anisotropic renormalization. Further, by performing anisotropic renormalization on the particles forming the flow field having a shape having a large aspect ratio, it is possible to further reduce the number of particles as compared with a case of performing isotropic renormalization. In this way, it is possible to reduce the amount of calculation necessary for analysis.

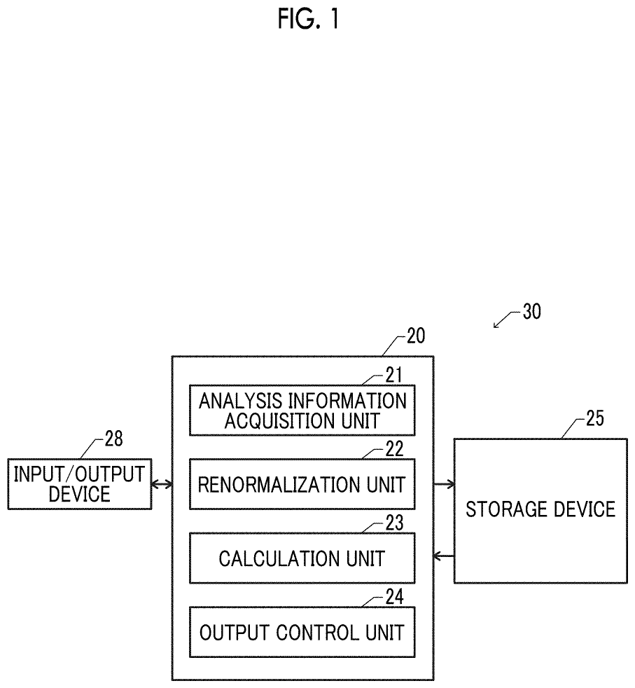

An analysis method and an analysis device according to an example will be described with reference to FIGS. 1 to 5.

FIG. 1 is a block diagram of an analysis device 30 according to the present example. The analysis device 30 according to the present example includes a processing device 20, a storage device 25, and an input/output device 28. The processing device 20 includes an analysis information acquisition unit 21, a renormalization unit 22, a calculation unit 23, and an output control unit 24.

The processing device 20 can be realized by hardware such as a central processing unit (CPU) of a computer, and a main memory, a computer program, and the like. In FIG. 1, functional blocks that are realized by the cooperation of hardware and software are shown.

The storage device 25 stores a program that is executed by the processing device 20, data necessary for analysis, and the like. As the storage device 25, for example, a hard disk drive (HDD), a solid state drive (SSD), or the like is used. When analysis is executed, the program stored in the storage device 25 is loaded into the main memory of the processing device 20.

The input/output device 28 has a function to receive the input of a command from a user, which is related to the processing that is executed in the processing device 20, a function to perform the input/output of data, a function to display figures, characters, or the like. As the input/output device 28, a keyboard, a pointing device, a touch panel, a communication device, a reading/writing device, a display device, a printer, or the like can be used. A user operates a keyboard, a pointing device, a touch panel, or the like, whereby the input of commands or data is performed. The communication device transmits and receives data through a network such as the Internet or a local area network (LAN). The reading/writing device reads data from a removable medium and writes data to the removable medium. The display device displays figures, characters, images, or the like. The printer prints figures, characters, images, or the like.

The analysis information acquisition unit 21 acquires analysis information necessary for executing analysis through the input/output device 28. Various kinds of information necessary for the analysis are included in the analysis information. For example, the shape and size of a flow field of a fluid to be analyzed, the physical property value of the fluid, information for representing the fluid by a plurality of particles, information for performing renormalization, a condition for ending the analysis, and the like are included in the analysis information.

The renormalization unit 22 performs renormalization processing on a particle system to be analyzed. A specific example of the renormalization processing will be described in detail later. The calculation unit 23 analyzes the motion of each particle by solving a motion equation that governs the motion of the particle system. The output control unit 24 outputs an analysis result to the input/output device 28.

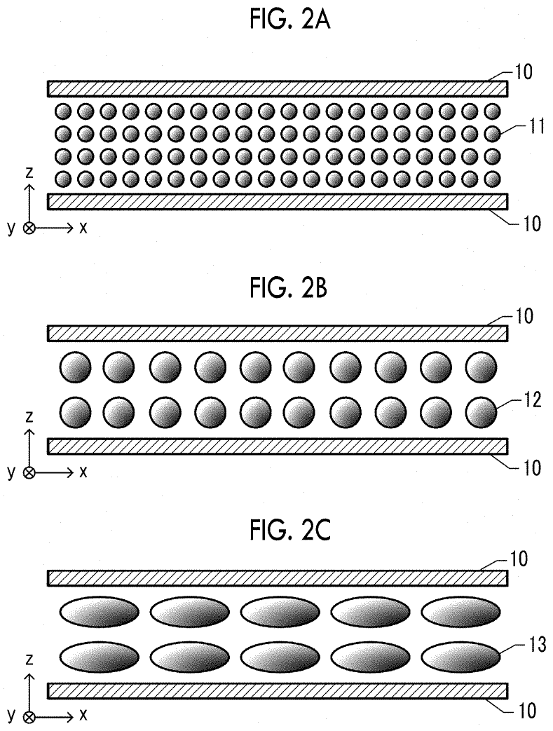

Next, a renormalization method will be described with reference to FIGS. 2A to 2C.

FIG. 2A is a schematic diagram of an analysis model in which a fluid to be analyzed is represented by a plurality of particles. The fluid to be analyzed is accommodated in a space interposed between a pair of parallel plates 10. The fluid is represented by a plurality of particles 11. The shape of each of the particles 11 can be considered to correspond to an equipotential surface of an interaction potential that is generated by the particles 11. In general, the shape of the equipotential surface of the interaction potential is a spherical shape. In FIG. 2A, each of the particles 11 is represented by an equipotential surface having a certain size. A xyz Cartesian coordinate system is defined in which the direction in which the parallel plates 10 are separated is a z direction. The dimension in the z direction of the space in which the fluid is accommodated is sufficiently smaller than the dimensions in an x direction and a y direction.

FIG. 2B is a schematic diagram showing a particle system in which isotropic renormalization has been performed on the particle system shown in FIG. 2A. The number of particles decreases due to the renormalization. The interaction potential is isotropically stretched in the x, y, and z directions. Therefore, in FIG. 2B, each of particles 12 after the renormalization is represented by a spherical surface larger than the particle 11 shown in FIG. 2A.

FIG. 2C is a schematic diagram showing a particle system in which renormalization has been further performed in the x direction and the y direction on the particle system shown in FIG. 2B without performing renormalization in the z direction. The number of particles further decreases due to the renormalization. Further, the interaction potential is stretched in the x direction and the y direction and is not stretched in the z direction. Therefore, in FIG. 2C, each of particles 13 after the renormalization is represented by a flat spheroid with the z direction as the minor axis direction. Isotropic Renormalization

Next, a renormalization transformation law in a case of performing isotropic renormalization on the particle system and the energy of the particle system will be described. The renormalization transformation law is expressed by the following expression.

$${N}_{R} = \frac{N}{{λ}^{3}} \\ {m}_{R} = {λ}^{3} m \\ {r}_{R} = r \\ {V}_{R} = V \\ {T}_{R} = {λ}^{3} T \qquad ( 1 )$$

Here, N is the number of particles, m is the mass of the particle, r is a position vector indicating the position of the particle, V is the volume of a flow field of a fluid, and T is the temperature of a particle system. The parameters with a subscript R represent parameters after the renormalization. A is a parameter representing the degree of renormalization, and A is a real number larger than 1. For example, when n is an integer of 1 or more and the degree of renormalization A is expressed by the following expression, n is called the number of times of renormalization.

λ=2ⁿ (2)

An interaction potential u(r) between particles is given with an inter-particle distance as r. When the distance r approaches infinity, in a case where u(r) approaches zero sufficiently fast (for example, in the case of the Lennard-Jones potential), the renormalization transformation law of the interaction potential u(r) is expressed by the following expression.

$$ι {ι}_{R} ( r ) = {λ}^{3} u ( \frac{r}{λ} ) \qquad ( 3 )$$

In a case where the renormalization processing is performed using the renormalization transformation law of the above Expressions (1) and (3), macroscopic physical quantities such as the energy and pressure of the particle system are invariable before and after the renormalization. Hereinafter, it is proved that the energy is invariable before and after the renormalization.

A partition function Z_{N} of the particle system is expressed by the following expression.

$${Z}_{N} = \frac{1}{N ! {h}^{3 N}} \int {d}^{3 N} r {d}^{3 N} {pe}^{- β H} \\ β = \frac{1}{{k}_{B} T} \\ H = \frac{1}{2 m} {\sum }_{i = 1}^{N} {p}_{i}^{2} + {\sum }_{i < j} u ( {r}_{ij} ) \qquad ( 4 )$$

Here, h is the Planck's constant, k_{B} is the Boltzmann's constant, r is the position vector of the particle, p is the momentum of the particle, and rᵢⱼ is the distance from an i-th particle to a j-th particle. The sigma of the first term on the right side of the third expression of Expression (4) means that all N particles are summed, and the sigma of the second term means that all particle pairs are summed.

A portion Z_{N:k} of the kinetic term of the partition function Z_{N} of Expression (4) is expressed by the following expression.

$$\begin{matrix}{Z}_{N : k} = \frac{{V}^{N}}{N !} \int {d}^{3 N} {pe}^{- β \frac{1}{2 m} {\sum }_{i = 1}^{N} {p}_{i}^{2}} \\ = \frac{{V}^{N}}{N !} {( \frac{2 π m}{β} )}^{\frac{3 N}{2}}\end{matrix} \qquad ( 5 )$$

Therefore, kinetic energy Eₖ is expressed by the following expression.

$${E}_{k} = - \frac{\partial }{\partial β} ln {Z}_{N : k} = \frac{3 N}{2 β} \qquad ( 6 )$$

When the renormalization of the degree of renormalization λ is performed, both N and β on the right side of Expression (6) become 1/λ³, and therefore, the energy E_{K} is invariable before and after the renormalization.

A portion Z_{N:int} of the interaction term of the partition function Z_{N} of Expression (4) is expressed by the following expression.

$${Z}_{N : int} = \frac{1}{{V}^{N}} \int {d}^{3 N} {re}^{- β U} \\ U = {\sum }_{i < j} u ( {r}_{ij} ) \qquad ( 7 )$$

When the distance rᵢⱼ approaches infinity, u(rᵢⱼ) approaches zero sufficiently fast, and therefore, when the relationship, r>r_{c}, is established using a certain cutoff distance r_{c}, the interaction potential u(r) can be approximated as follows.

u(r)=0

e^{-βu(r)}=1 (8)

A case is considered where the cutoff distance r_{c} is sufficiently smaller than lengths Lₓ, L_{y}, and L_{z} in the x, y, and z directions of the space accommodating the fluid and particle number density N/V is sufficiently small. In this case, the probability that other particles are present in the range where the distance from each particle is equal to or less than the cutoff distance r_{c} is extremely small. In particular, the probability that two or more other particles are present in the range where the distance from each particle is equal to or less than the cutoff distance r_{c} may be regarded as zero. Therefore, the multiple integral (Expression (7)) of the partition function Z_{N:int} can be approximated as follows.

$${Z}_{N : int} \approx {( \int \frac{{d}^{3} r}{V} {e}^{- β u ( r )} )}^{\frac{N ( N - 1 )}{2}} = {( \int \frac{{d}^{3} r}{V} f ( r ) + 1 )}^{\frac{N ( N - 1 )}{2}} \approx exp ( \frac{N ( N - 1 )}{2} \int \frac{{d}^{3} r}{V} f ( r ) ) \approx exp ( \frac{{N}^{2}}{2 V} \int {d}^{3} rf ( r ) ) \\ f ( r ) = {e}^{- β u ( r )} - 1 \qquad ( 9 )$$

Therefore, interaction energy Eᵢₙₜ can be described by the following expression.

$${E}_{int} = - \frac{\partial }{\partial β} ( \frac{{N}^{2}}{2 V} \int {d}^{3} rf ( r ) ) \qquad ( 10 )$$

Total energy E of the particle system is defined by the following expression.

E=Eₖ+Eᵢₙₜ (11)

When the cutoff distance r_{c} is sufficiently smaller than Lₓ, L_{y}, and L_{z} and the inter-particle distance r is larger than the cutoff distance r_{c}, the relationship, u(r)=0, can be approximated, and therefore, the volume integration of Expression (10) can be approximated as follows.

$$\int {d}^{3} rf ( r ) = {\int }_{- {L}_{x} / 2}^{{L}_{x} / 2} dx {\int }_{- {L}_{y} / 2}^{{L}_{y} / 2} dy {\int }_{- {L}_{z} / 2}^{{L}_{z} / 2} dzf ( r ) \approx {\int }_{- ∞}^{∞} dx {\int }_{- ∞}^{∞} dy {\int }_{- ∞}^{∞} dzf ( r ) \qquad ( 12 )$$

Interaction energy E_{int,R} after the renormalization transformation is approximated by the following expression.

$${E}_{int , R} = - \frac{\partial }{\partial ( β / {λ}^{3} )} \times ( \frac{{( N / {λ}^{3} )}^{2}}{2 V} \int ( {e}^{- ( β / {λ}^{3} ) ( {λ}^{3} u ( r / λ ) )} - 1 ) {d}^{3} r ) \qquad ( 13 )$$

In order for the approximation of Expression (12) to be established, it is necessary to satisfy the condition that a cutoff distance r_{cR} after the renormalization transformation is sufficiently smaller than Lₓ, L_{y}, and L_{z}. From Expression (3), the cutoff distance r_{cR} after the renormalization transformation is A times the cutoff distance r_{c} before the renormalization transformation. If the degree of renormalization λ is large, the cutoff distance r_{cR} becomes longer. Therefore, the upper limit of the degree of renormalization λ is restricted by the condition that the cutoff distance r_{cR} after the renormalization transformation is sufficiently smaller than Lₓ, L_{y}, and L_{z}.

When variable transformation of r into λr is performed in Expression (13), Expression (13) becomes the same as the right side of Expression (10). Therefore, the relationship, E_{int,R}=Eᵢₙₜ, is established, and the interaction energy Eᵢₙₜ is also invariable before and after the renormalization.

In this manner, when the isotropic renormalization is performed using the renormalization transformation law shown in Expression (1), the kinetic energy and the interaction energy of the system are invariable before and after the renormalization. Therefore, the energy of the entire system shown in Expression (11) is also invariable before and after the renormalization.

### Renormalization in Two Directions

Next, a case where the cutoff distance r_{c} is sufficiently shorter than the dimension Lₓ in the x direction and the dimension L_{y} in the y direction of the flow field, but is not sufficiently shorter than the dimension L_{z} in the z direction will be described. For example, this condition is satisfied in a case where the flow field has a thin plate shape with the z direction as the thickness direction.

In a case where the shape of the flow field satisfies such a condition, the renormalization is not performed in the z direction and is performed only in two directions: the x direction and the y direction. The renormalization transformation law is expressed by the following expression.

$${N}_{R} = \frac{N}{{λ}^{2}} \\ {m}_{R} = {λ}^{2} m \\ {r}_{R} = r \\ {V}_{R} = V \\ {T}_{R} = {λ}^{2} T \qquad ( 14 )$$

The interaction potential follows the following transformation law.

$${u}_{R} ( r ) = {λ}^{2} u ( \tilde{r} ) \\ \tilde{r} = \sqrt{\frac{{x}^{2}}{{λ}^{2}} + \frac{{y}^{2}}{{λ}^{2}} + {z}^{2}} \qquad ( 15 )$$

Even in a case where the renormalization transformation of Expression (14) is performed, the kinetic energy that is represented by Expression (6) is invariable before and after the renormalization.

The volume integration of Expression (10) can be approximated as follows.

$$\int {d}^{3} rf ( r ) = {\int }_{- {L}_{x} / 2}^{{L}_{x} / 2} dx {\int }_{- {L}_{y} / 2}^{{L}_{y} / 2} dy {\int }_{- {L}_{z} / 2}^{{L}_{z} / 2} dzf ( r ) \approx {\int }_{- ∞}^{∞} dx {\int }_{- ∞}^{∞} dy {\int }_{- {L}_{z} / 2}^{{L}_{z} / 2} dzf ( r ) \qquad ( 16 )$$

The interaction energy E_{int,R} after the renormalization transformation is approximated by the following expression.

$${E}_{int , R} = - \frac{\partial }{\partial ( \frac{β}{{λ}^{2}} )} \times ( \frac{{( \frac{N}{{λ}^{2}} )}^{2}}{2 V} \int ( {e}^{- ( \frac{β}{{λ}^{2}} ) ( {λ}^{3} u ( \tilde{r} ) )} - 1 ) {d}^{3} r ) \qquad ( 17 )$$

Here, the r tilde is the same as the r tilde of Expression (15). When variable transformation of x into λx and variable transformation of y into λy are performed in Expression (17), the right side of Expression (17) becomes the same as the right side of Expression (10). Therefore, the relationship, E_{int,R}=Eᵢₙₜ, is established, and the interaction energy Eᵢₙₜ is also invariable before and after the renormalization.

In this manner, by performing the anisotropic renormalization, based on the renormalization transformation law in two directions shown in Expression (14), it is possible to make the energy of the particle system invariable before and after the renormalization.

### Renormalization in One Direction

Next, a case where the cutoff distance r_{c} is sufficiently shorter than the dimension Lₓ in the x direction of the flow field, but is not sufficiently shorter than the dimension L_{y} in the y direction and the dimension L_{z} in the z direction will be described. For example, this condition is satisfied in a case where the flow field has an elongated column shape with the x direction as the length direction.

In a case where the shape of the flow field satisfies such a condition, the renormalization is not performed in the y direction and the z direction and is performed only in the x direction. The renormalization transformation law is expressed by the following expression.

$${N}_{R} = \frac{N}{λ} \\ {m}_{R} = λ m \\ {r}_{R} = r \\ {V}_{R} = V \\ {T}_{R} = λ T \qquad ( 18 )$$

The interaction potential follows the following transformation law.

$${u}_{R} ( r ) = λ u ( \tilde{r} ) \\ \tilde{r} = \sqrt{\frac{{x}^{2}}{{λ}^{2}} + {y}^{2} + {z}^{2}} \qquad ( 19 )$$

Even in a case of performing the renormalization transformation of Expression (18), the kinetic energy that is represented by Expression (6) is invariable before and after the renormalization.

The volume integration of Expression (10) can be approximated as follows.

$$\int {d}^{3} rf ( r ) = {\int }_{- {L}_{x} / 2}^{{L}_{x} / 2} dx {\int }_{- {L}_{y} / 2}^{{L}_{y} / 2} dy {\int }_{- {L}_{z} / 2}^{{L}_{z} / 2} dzf ( r ) \approx {\int }_{- ∞}^{∞} dx {\int }_{- {L}_{y} / 2}^{{L}_{y} / 2} dy {\int }_{- {L}_{z} / 2}^{{L}_{z} / 2} dzf ( r ) \qquad ( 20 )$$

The interaction energy E_{int,R} after the renormalization transformation is approximated by the following expression.

$${E}_{int , R} = - \frac{\partial }{\partial ( \frac{β}{λ} )} \times ( \frac{{( \frac{N}{λ} )}^{2}}{2 V} \int ( {e}^{- ( \frac{β}{λ} ) ( λ u ( \tilde{r} ) )} - 1 ) {d}^{3} r ) \qquad ( 21 )$$

Here, the r tilde is the same as the r tilde of Expression (19). When variable transformation of x into λx is performed in Expression (21), the right side of Expression (21) becomes the same as the right side of Expression (10). Therefore, the relationship, E_{int,R}=Eᵢₙₜ, is established, and the interaction energy Eᵢₙₜ is also invariable before and after the renormalization.

In this manner, by performing the anisotropic renormalization, based on the renormalization transformation law in one directions shown in Expression (18), it is possible to make the energy of the particle system invariable before and after the renormalization.

### Generalization of Anisotropic Renormalization

The renormalization transformation law in a case where the renormalization is performed in two directions and is not performed in the remaining one direction is shown in Expression (14), and the renormalization transformation law in a case where the renormalization is not performed in the two directions and is performed in only the remaining one direction is shown in Expression (18). Next, a case where the degree of renormalization is determined with respect to each of the three directions and the anisotropic renormalization is performed will be described.

The degrees of renormalization in the x, y, and z directions are marked as λₓ, λ_{y}, and λ_{z}. The renormalization transformation law in this case is expressed by the following expression.

$${N}_{R} = \frac{N}{{λ}_{x} {λ}_{y} {λ}_{z}} \\ {m}_{R} = {λ}_{x} {λ}_{y} {λ}_{z} m \\ {r}_{R} = r \\ {V}_{R} = V \\ {T}_{R} = {λ}_{x} {λ}_{y} {λ}_{z} T \qquad ( 22 )$$

The interaction potential follows the following transformation law.

$${u}_{R} ( r ) = {λ}_{x} {λ}_{y} {λ}_{z} u ( \tilde{r} ) \\ \tilde{r} = \sqrt{\frac{{x}^{2}}{{λ}_{x}^{2}} + \frac{{y}^{2}}{{λ}_{y}^{2}} + \frac{{z}^{2}}{{λ}_{z}^{2}}} \qquad ( 23 )$$

Cutoff distances r_{cxR}, r_{cyR}, and r_{czR} in the x, y, and z directions of the interaction potential u_{R}(r) after the renormalization transformation are expressed by the following expression.

r_{cxR}=λₓr_{c}

r_{cyR}=λ_{y}r_{c}

r_{czR}=λ_{z}r_{c} (24)

In this case, it is preferable to satisfy the following conditions in order for an approximation similar to the approximations of Expressions (12), (16), and (20) to be established.

r_{cxR}<<Lₓ

r_{cyR}<<L_{y}

r_{czR}<<L_{z} (25)

### Analysis of Behavior of Particle System

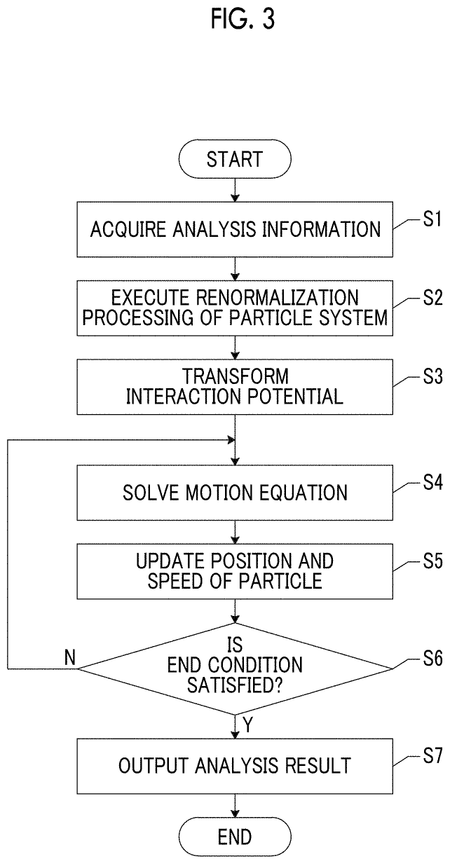

Next, a method of performing the analysis of the behavior of the particle system will be described with reference to FIG. 3.

FIG. 3 is a flowchart of the analysis method according to the example. First, the analysis information acquisition unit 21 (FIG. 1) acquires the analysis information input to the input/output device 28 (FIG. 1) (step S1). Next, the renormalization unit 22 (FIG. 1) executes the renormalization processing on the particle system, based on the renormalization transformation law shown in Expression (14), (18), or (22) (step S2). Further, the interaction potential is transformed based on the transformation law shown in Expression (15), (19), or (23) (step S3). When the transformation according to Expression (15) is performed, the shape of the equipotential surface of the interaction potential that is applied to the particle system after the renormalization coincides with the shape of the surface of a flat spheroid with the z direction as the minor axis direction. When the transformation according to Expression (19) is performed, the shape of the equipotential surface of the interaction potential that is applied to the particle system after the renormalization coincides with the shape of the surface of a prolate spheroid with the x direction as the major axis direction.

Next, the calculation unit 23 (FIG. 1) numerically solves the motion equation that governs the motion of the particle system after the renormalization by one time step (step S4). The position and speed of the particle are updated based on the solution of the motion equation (step S5). Step S4 and step S5 are repeatedly executed until an end condition is satisfied (step S6). When the end condition is satisfied, the output control unit 24 (FIG. 1) outputs the analysis result to the input/output device 28 (FIG. 1) (step S7).

Next, the excellent effect of the example described above will be described.

In a case of analyzing the flow field having a shape with a large aspect ratio by using an isotropic renormalized molecular dynamics method, the degree of renormalization A is restricted according to the minimum dimension of the flow field. Therefore, even if the renormalization is performed, the effect of reducing the number of particles is limited.

In contrast, in the above example, the number of particles can be further reduced by making the degree of renormalization A different for each direction according to the dimensions in the three directions that characterize the shape of the flow field to be analyzed. By reducing the number of particles, the amount of calculation necessary for analysis can be reduced, and the calculation cost can be reduced. Further, it becomes possible to perform analysis of a larger system without increasing the amount of calculation. In particular, in a case where the aspect ratio of the shape of the flow field is 10 or more, a remarkable effect of applying the analysis method according to the above example can be obtained.

Next, the “three directions that characterize the shape” will be described. When a direction to give the shortest dimension or a direction to give the longest dimension of a three-dimensional shape is uniquely determined, the direction is determined as a first direction. When the direction to give the longest dimension or the shortest dimension is uniquely determined with respect to two directions orthogonal to each other in a plane orthogonal to the first direction, the direction is set as a second direction and the remaining direction is set as a third direction. When the direction to give the longest dimension or the shortest dimension is not determined with respect to two directions orthogonal to each other in a plane orthogonal to the first direction, the second direction and the third direction are optionally determined. The first, second, and third directions correspond to the three directions that characterize the shape.

Further, even if the anisotropic renormalization according to the above example is performed, the position vector r indicating the position of the particle and the volume V of the flow field are invariable before and after the renormalization. Therefore, it is possible to perform analysis that sufficiently reflects the behavior of the flow field to be analyzed.

Next, an example of a procedure for actually performing the renormalization will be described.

First, the isotropic renormalization is performed on the particle system according to the shortest direction of the three directions that characterize the shape of the flow field to be analyzed. The anisotropic renormalization is further performed in other directions on the isotropically renormalized particle system. In this case, further renormalization is not performed in the shortest direction.

### Transformation Law of Viscosity in Isotropic Renormalization

A transformation law of viscosity by the renormalization in a case where the isotropic renormalization has been performed on the particle system representing a fluid will be described.

A case where the interaction potential u(r) is the Lennard-Jones potential will be described. The interaction potential u(r) is expressed by the following expression.

$$u ( r ) = 4 ɛ [ {( \frac{σ}{r} )}^{12} - {( \frac{σ}{r} )}^{6} ] \qquad ( 26 )$$

Here, ϵ and σ are fitting parameters.

Viscosity η of the fluid that is represented by the Lennard-Jones potential of Expression (26) is represented by the following expression.

$$η = \frac{1}{3} \sqrt{\frac{8 {mk}_{B} T}{{π}^{3}}} \frac{1}{{d}^{2}} \\ d = {2}^{1 / 6} σ \qquad ( 27 )$$

When the interaction potential is transformed as shown in Expression (3) by using the renormalization transformation law of Expression (1), the following expression is obtained.

$${u}_{R} ( r ) = 4 {λ}^{3} ɛ [ {( \frac{λσ}{r} )}^{12} - {( \frac{λσ}{r} )}^{6} ] \qquad ( 28 )$$

Comparing Expression (26) and Expression (28), it can be seen that the fitting parameters s and o are transformed as follows by the renormalization.

ϵ_{R}=λ³ϵ

σ_{R}=λσ (29)

When transformation is performed on the mass m, the temperature T, and the parameter d on the right side of Expression (27), based on the transformation law, the following expression is obtained as the transformation law of the viscosity η.

η_{R}=λη (30)

### Transformation Law of Viscosity in Anisotropic Renormalization

Next, the transformation law of viscosity in a case of performing the anisotropic renormalization according to the above example will be described. The inventor of the present application performed the anisotropic renormalization on the particle system representing the fluid to be analyzed, and performed simulation to obtain the viscosity η that is indicated by the particle system after the renormalization.

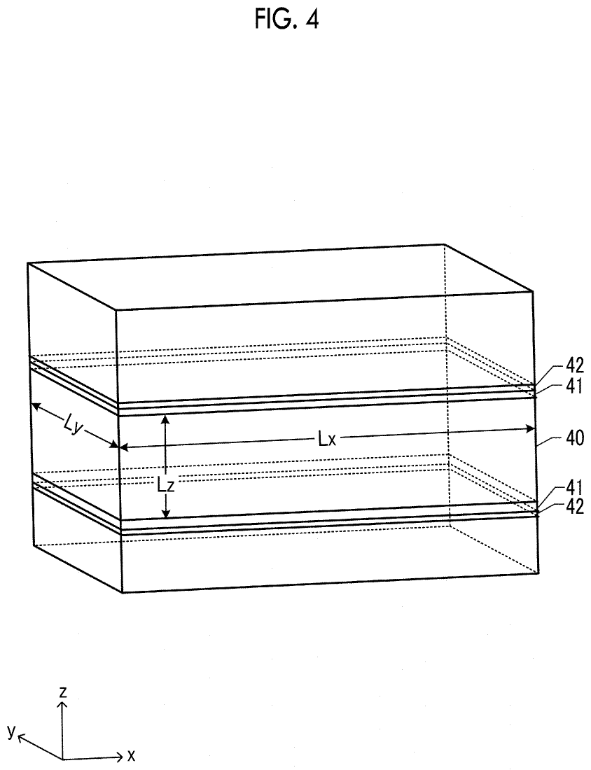

FIG. 4 is a schematic diagram showing an analysis model in which analysis is actually performed. A space 40 in which the fluid is accommodated is interposed between a pair of elastic body plates 41 in the z direction, and a rigid body plate 42 is disposed on the outside of each of the elastic body plates. Aperiodic boundary condition is applied in the x and y directions. The Lennard-Jones potential is used as the interaction potential of the particle system representing a fluid. In the analysis, the temperature of the elastic body plate 41 is controlled.

Both the dimensions Lx and Ly in the x direction and the y direction of the space 40 in which the fluid is accommodated were set to be 1.235×10⁻⁷ m, and the dimension Lz was set to be 1.543×10⁻⁸ m. The physical property value of argon was used as the physical property value describing the particle before the renormalization. Specifically, the mass of the particle was set to be 39.95 g/mol, the fitting parameter ϵ of the Lennard-Jones potential was set to be 119.8×k_{B}, and o was set to be 3.41×10⁻¹⁰ m. Here, k_{B} is the Boltzmann's constant. The cutoff distance r_{c} was set to be 1.1935×10⁻⁹ m. In this case, the condition that the cutoff distance r_{c} is sufficiently smaller than the dimensions Lx, Ly, and Lz is satisfied. The distance from a boundary surface on one side to which the periodic boundary condition is applied to a boundary surface on the other side is adopted as the dimensions Lx and Ly in the x and y directions to which the periodic boundary condition is applied.

In the original use of the simulation, the number of particles is reduced by the renormalization transformation and the amount of calculation is reduced. However, since the purpose of this simulation is to derive the transformation law of viscosity, the number of particles was set to be invariable before and after the renormalization transformation. Specifically, when the degree of renormalization in a certain direction is λ, the dimension in a renormalization direction of the space of the analysis model is λ times the dimension of the space of the analysis model before the renormalization. For example, the dimensions Lₓ in the x direction of the space of the analysis model in a case where the number of times of renormalization n in the x direction was set to be once, twice, and thrice are set to be 2 times, 4 times, and 8 times, respectively.

Viscosity was calculated from a flow velocity and an external force by fixing the rigid body plate 42 on one side and applying a force to the rigid body plate 42 on the other side to slide it in the x direction. The analysis was performed with respect to a case of performing renormalization in the x direction, a case of performing renormalization in the y direction, and a case of performing renormalization in the z direction. Further, the analysis was performed with respect to cases where the number of times of renormalization n that is defined in Expression (2) was set to be once, twice, and thrice.

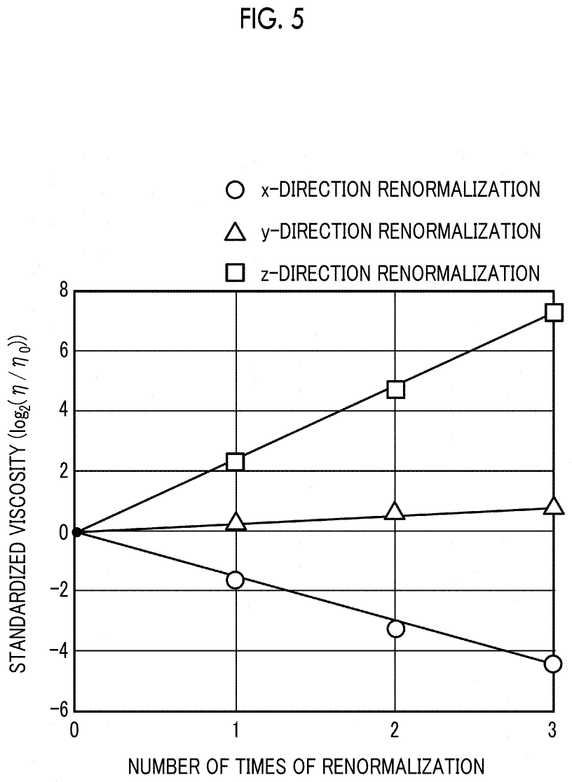

FIG. 5 is a graph showing analysis results. The horizontal axis represents the number of times of renormalization n. The vertical axis represents the viscosity obtained by the analysis with a standardized value on the basis of the viscosity of the particle system before the renormalization. Specifically, when the viscosity of the particle system before the renormalization is marked as η₀ and the viscosity obtained by the analysis is marked as η, the vertical axis represents log₂(η/η₀).

A circle symbol, a triangle symbol, and a square symbol in the graph indicate the analysis results in cases where the renormalization was performed in the x direction, the y direction, and the z direction, respectively. It can be seen that the obtained viscosity η is different according to the renormalization direction and the number of times of renormalization. From the analysis results, viscosities η_{R:x}, η_{R:y}, and η_{R:z} obtained by performing the analysis by performing the renormalization in the x direction, the y direction, and the z direction are approximated by the following expression.

η_{R:x}=λ^{-1.53}η

η_{R:y}=λ^{0.29}η

η_{R:z}=λ^{2.38}η (31)

When multiplied in the three directions, viscosity η_{R:xyz} of the particle system after the renormalization is expressed by the following expression.

η_{R:xyz}=λ^{1.14}η (32)

Expression (32) well coincides with the viscosity η_{R} of the particle system subjected to the isotropic renormalization shown in Expression (30).

From the transformation law of viscosity represented by Expression (31), it is possible to infer the property of the particle system analyzed by the anisotropic renormalization. Further, when the viscosity of the particle system after the renormalization is known, the flow velocity can be set such that the Reynolds number of the flow field to be analyzed and the Reynolds number of the flow field of the particle system after the renormalization are substantially the same. By making the Reynolds number of the particle system after the renormalization almost the same as the Reynolds number of the flow field to be analyzed, it is possible to perform analysis that sufficiently reflects the collaboration of the original flow field.

In the simulation shown in FIGS. 4 and 5, the surface of each of the elastic body plates 41 sandwiching the fluid therebetween is set to be flat. However, it is also possible to perform simulation of a flow field sandwiched between parallel plates provided with a plurality of dimples on the surfaces. For example, the analysis method according to the above example can be applied to a sliding problem in which a minute gap is filled with lubricating oil. In order to reproduce the influence of the dimple on the flow field, it is favorable if the renormalization transformation is performed such that the condition that the cutoff distance after the renormalization transformation is sufficiently smaller than the dimensions in the x direction, the y direction, and the z direction of the dimple is satisfied.

The example described above is exemplification, and the present invention is not limited to the example described above. For example, it will be obvious to those skilled in the art that various changes, improvements, combinations, and the like are possible.

It should be understood that the invention is not limited to the above-described embodiment, but may be modified into various forms on the basis of the spirit of the invention. Additionally, the modifications are included in the scope of the invention.

What is claimed is:

1. An analysis method of analyzing a behavior of a particle system that includes a plurality of particles forming a flow field, by using a renormalized molecular dynamics method, comprising:
performing renormalization on the particle system according to a degree of renormalization determined for each of three directions orthogonal to each other according to a shape of the flow field by the particle system to be analyzed; and
numerically solving a motion equation that governs a motion of the particle system with respect to the particle system after the renormalization,
wherein in the performing of renormalization,
a number of particles is reduced according to the degree of renormalization, and mass of each of the particles is increased according to the degree of renormalization without changing a shape and volume of the flow field before and after the renormalization, and
an interaction potential between the particles is transformed according to the degree of renormalization in each of the three directions.

2. The analysis method according to claim 1, wherein a dimension in a first direction of the flow field to be analyzed is smaller than dimensions in second and third directions, the degree of renormalization in the first direction is smaller than the degrees of renormalization in the second direction and the third direction, and the degree of renormalization in the second direction and the degree of renormalization in the third direction are the same, and
a shape of an equipotential surface of an interaction potential before the renormalization is a substantially spherical shape, and a shape of the equipotential surface of the interaction potential after the renormalization coincides with a shape of a surface of a flat spheroid with the first direction as a minor axis direction.

3. The analysis method according to claim 1, wherein a dimension in a first direction of the flow field to be analyzed is larger than dimensions in second and third directions, the degree of renormalization in the first direction is larger than the degrees of renormalization in the second direction and the third direction, and the degree of renormalization in the second direction and the degree of renormalization in the third direction are the same, and
a shape of an equipotential surface of an interaction potential before the renormalization is a substantially spherical shape, and a shape of the equipotential surface of the interaction potential after the renormalization coincides with a shape of a surface of a prolate spheroid with the first direction as a major axis direction.

4. An analysis device for analyzing a behavior of a particle system that includes a plurality of particles forming a flow field, comprising:
an input/output device to which analysis information that includes information for defining a shape of the flow field to be analyzed and information for defining a degree of renormalization for each of three directions orthogonal to each other in the flow field to be analyzed is input; and
a processing device that analyzes the behavior of the particle system by using a renormalized molecular dynamics method, based on the analysis information input from the input/output device,
wherein the processing device is capable of
performing renormalization that reduces a number of particles according to the degree of renormalization, and increases mass of each of the particles according to the degree of renormalization without changing the shape and volume of the flow field before and after the renormalization,
transforming an interaction potential between the particles according to the degree of renormalization in each of the three directions, and
numerically solving a motion equation that governs a motion of the particle system with respect to the particle system after the renormalization.

5. A computer readable medium storing a program that causes a computer to execute a proces s for analyzing a behavior of a particle system that includes a plurality of particles forming a flow field, the process comprising:
acquiring analysis information that includes information for defining a shape of the flow field to be analyzed and information for defining a degree of renormalization for each of three directions orthogonal to each other in the flow field to be analyzed;
performing renormalization that reduces a number of particles according to the degree of renormalization, and increases mass of each of the particles according to the degree of renormalization without changing the shape and volume of the flow field before and after the renormalization;
transforming an interaction potential between the particles according to the degree of renormalization in each of the three directions, and
numerically solving a motion equation that governs a motion of the particle system with respect to the particle system after the renormalization.
